(19) United States
(12) Patent Application Publication
(10) Pub. No.: US 2013/0221953 A1
(43) Pub. Date: Aug. 29, 2013

(54) ABSOLUTE POSITION RECORDING DEVICE OF MOTOR

(71) Applicants: TSANN-HUEI CHANG, Tu-Chen (TW); CHIH-JUNG LIU, Tu-Chen (TW); CHENG-EN CHIEN, Tu-Chen (TW)

(72) Inventors: TSANN-HUEI CHANG, Tu-Chen (TW); CHIH-JUNG LIU, Tu-Chen (TW); CHENG-EN CHIEN, Tu-Chen (TW)

(21) Appl. No.: 13/689,795

(22) Filed: Nov. 30, 2012

(30) Foreign Application Priority Data
Feb. 24, 2012 (TW) 101106431

(51) Int. Cl. G01B 7/30

(52) U.S. Cl. CPC G01B 7/30
USPC 324/207.15

(57) ABSTRACT

An absolute position recording device of a motor includes a main spindle, a magnetic ring, a magnetic induction unit, an encoder, a counter, and an operation unit. The magnetic ring and the encoder are fixed on and rotated by the main spindle. The magnetic induction unit outputs square waves and the encoder outputs sine or cosine waves. The counter receives the square waves and calculates a number of rotations of the magnetic ring. The operation unit receives the sine or cosine waves and calculates an angular deflection relative to a standard position of the magnetic ring. The operation unit adds the angular deflection and the number of rotations and calculates an absolute angular position.

### BACKGROUND

1. Technical Field

This present disclosure relates to motors, and particularly to an absolute position recording device of a motor.

2. Description of Related Art

An alternating current (AC) servo motor records an absolute angular position of the motor when power to the motor is cut off using an absolute position recording device, which can either be an optical or a mechanical device. In the optical device, an optical encoder simultaneously reads a rotational cyclical number of rotations of the motor and a deflected angle relative to a standard position equal to a stop location of the motor of the last time. In the mechanical device, a set of gears rotate an encoder. An encoder obtains a rotational cyclical number of a rotor and a deflected angle relative to a standard position of the motor by measuring an angular displacement of the rotor in rotation. But, the optical device is compromised by smoke, dust, and a hostile environment, and designing cost is more expensive when packaging. The mechanical device requires high quality gearing, and thus more expense, and mechanical structure of the device is more complicated. Therefore, there is room for improvement within the art.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the present embodiments.

FIG. 1 is a plan view of one embodiment of an absolute position recording device of a motor.

FIG. 2 is a schematic or block diagram of one embodiment of the absolute position recording device shown FIG. 1.

### DETAILED DESCRIPTION

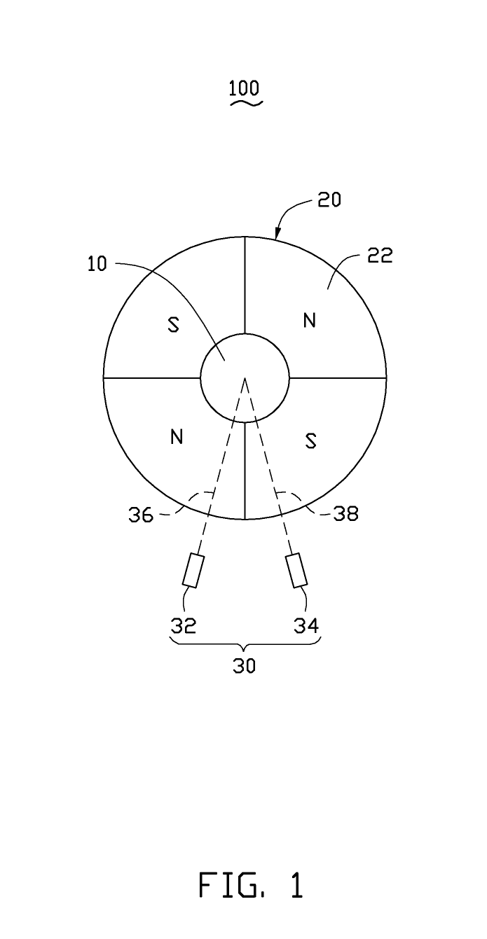

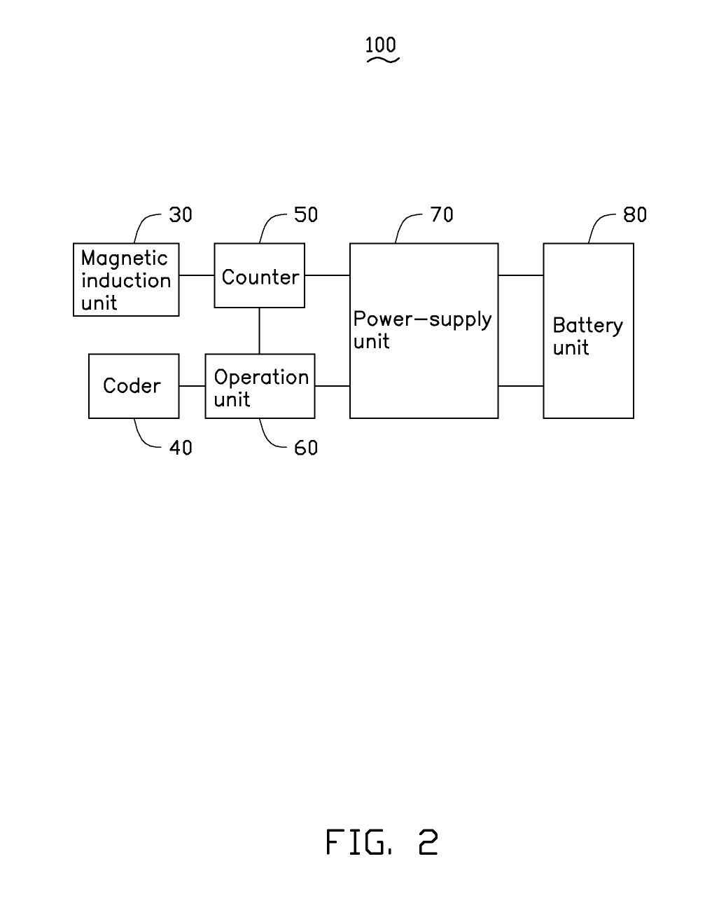

FIG. 1 and FIG. 2 illustrate one embodiment of an absolute position recording device 100 of a motor. The device applies a mechanism to the motor to detect an absolute angular position of the motor after execution of a command.

The absolute position recording device 100 of the motor includes a main spindle 10, a magnetic ring 20, a magnetic induction unit 30, an encoder 40, a counter 50, an operation unit 60, a power-supply unit 70, and a battery unit 80.

The main spindle 10 is in a structure of the motor, and can spin clockwise or counterclockwise in a fixed speed.

The magnetic ring 20 is carried on the main spindle 10 and rotates with the main spindle 10. In the embodiment, the magnetic ring 20 is surrounded by four identical magnets 22. Magnetic poles of two adjacent magnets are opposite, thus (going around the circle), north magnetic poles and south magnetic poles of the magnets 22 alternate.

A charge is induced in the magnetic induction unit 30 reflecting changes of magnetic poles of the magnetic ring 20, and an electric signal is produced according to the charge. In the embodiment, the magnetic induction unit 30 includes a first Hall effect element 32 and a second Hall effect element 34. The first Hall effect element 32 and the second Hall effect element 34 are set around the magnetic ring 20. Preferably, an angle between a first connecting line 36 between a center of the first Hall effect element 32 and a center of the magnetic ring 20 and a second connecting line 38 between a center of the second Hall effect element 34 and the center of the magnetic ring 20 is forty-five degrees. The first Hall effect element 32 and the second Hall effect element 34 output a high level voltage signal (e.g., 1.8V) when a charge is induced by a north magnetic pole of the magnetic ring 20, and output a low level voltage signal (e.g., 0V) when a charge is induced by a south magnetic pole of the magnetic ring 20. When the magnetic ring 20 spins one rotation, the first Hall effect element 32 and the second Hall effect element 34 output two square waves. An angle between the magnetic induction unit 30 and the center of the magnetic ring 20 is forty-five degrees, such that the square wave outputted from the first Hall effect element 32 and the second Hall effect element 34 are shifted in phase by forty-five degrees. When the square wave from the first Hall effect element 32 is phase-leading, the magnetic ring 20 is spinning clockwise. When the square wave from the second Hall effect element 34 is phase-leading, the magnetic ring 20 is spinning counterclockwise.

In the embodiment, the encoder 40 is an incremental-type encoder fixed on the main spindle 10, and spins with the main spindle 10. The encoder 40 outputs a sine or a cosine wave according to the rotation of the main spindle 10, to express the angular rotation of the magnetic ring 20 in one circle. The counter 50 is electronically connected to the first Hall effect element 32 and the second Hall effect element 34 simultaneously to receive the signals in the form of square waves (square wave signals) outputted from those elements. The counter 50 calculates a number of rotations of the magnetic ring 20 according to the square wave signals.

When a phase of the square wave signal outputted from the first Hall effect element 32 is leading a phase of the square wave signal outputted from the second Hall effect element 34, the counter 50 calculates the number of rotations of the magnetic ring 20 by the square wave signals outputted from the first Hall effect element 32, and the number will be a positive value. In the embodiment, the number of rotations is a rounded number equal to the number of the square wave signals divided by two. For example, when the number of the square wave signals outputted from the first Hall effect element 32 is nine, the number of rotations will be four. When the phase of the square wave signals outputted from the second Hall effect element 34 is leading the phase of the square wave signal outputted from the first Hall effect element 32, the number of rotations will be a negative value.

In the embodiment, the operation unit 60 is a digital signal processor (DSP). The operation unit 60 is electronically connected to the encoder 40 to receive the signals in the form of sine or cosine waves (sine or cosine wave signal) outputted from the encoder 40. And the operation unit 60 calculates the deflected angle relative to the standard position according to the sine or cosine wave signal. The magnitude of the angle is between −360 degrees and +360 degrees, and the accuracy depends upon the resolution of the operation unit 60.

At the same time, the operation unit 60 is electronically connected to the counter 50 to add the deflected angle relative to the standard position of the magnetic ring 20 and the number of rotations of the magnetic ring 20 is calculated by the counter 50.

Thus, the operation unit 60 calculates the absolute position of the motor according to a process of addition. The power supply unit 70 is electronically connected to the counter 50 and the operation unit 60 to maintain power for the counter 50 and the operation unit 60. The battery unit 80 is electric connected to the power-supply unit 70. The battery unit 80 supplies back-up electrical power when no power is supplied by the power-supply unit 70, to maintain the counter 50 and the operation unit 60 in a working state. Therefore, at the moment that the power-supply unit 70 restores electrical power, the absolute position of the motor can be obtained by the counter device 60. This arrangement avoids loss of information because of electrical service interruption.

The battery unit 80 further includes a recharging circuit (not shown) to extend the using time of the battery. The following explains the practical working of the absolute position recording device 100 of a motor: At first, the motor starts working. The magnetic ring 20 is rotated with the main spindle 10. For example, the magnetic ring 20 is rotated clockwise with the main spindle 10. At this time, the first Hall effect element 32 and the second Hall effect element 34 output the square wave signals, and the first Hall effect element 32 will be leading-phase.

The encoder 40 is rotated with the main spindle 10 and outputs the square wave signals. When the motor stops rotating, the counter 50 calculates an elapsed number of rotations of the magnetic ring 20 according to the square wave signal outputted from the first Hall effect element 32. The operation unit 60 calculates the deflected angle relative to the absolute position of the magnetic ring 20 according to the sine or cosine wave signal outputted from the encoder 40. Then the operation unit 60 adds the deflected angle and the number of rotations. Finally, the operation unit 60 calculates the absolute position of the motor according to the result of adding the deflected angle to the number of rotations.

The magnetic ring 20 of the present disclosure can be surrounded by eight or sixteen magnets 22. The angle between the first connecting line 36 between the first Hall effect element 32 and the center of magnetic ring 20, and the second connecting line 38 between the second Hall effect element 34 and the center of magnetic ring 20 will be changed to 22.5 or 11.25 degrees accordingly.

The absolute position recording device 100 of a motor of the present disclosure sets the magnetic ring 20 on the main spindle 10, and produces square wave signals by the charge induced in the magnetic induction unit 30 as the magnetic poles of the magnetic ring 20 pass by alternately. At the same time, the encoder 40 outputs the sine or cosine wave signal. The operation unit 60 calculates the deflected angle relative to the absolute position of the magnetic ring 20 according to the sine or cosine wave signals.

Then the operation unit 60 adds the deflected angle and the number of rotations to calculate the absolute position of the motor. The absolute position recording device 100 of a motor has a simple structure and a low cost. The entire device is not vulnerable to smoke and dust and the like. The device is very reliable.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An absolute position recording device of a motor, comprising:
a main spindle;
a magnetic ring and a encoder set on the main spindle; the main spindle rotating the magnetic ring and the encoder, the magnetic ring surrounded by a plurality of magnets, and the encoder outputting signals in the form of sine or cosine waves according to rotations of the main spindle;
a magnetic induction unit inducing a charge reflecting a change of magnetic poles of the magnets, and outputting signals in the form of square waves;
a counter electronically connected to the magnetic induction unit to receive the signals in the form of square waves and calculate a cyclical number of revolutions of the magnetic ring according to the signals in the form of square waves; and
an operation unit electronically connected to the encoder to receive the signals in the form of sine or cosine waves and calculate a deflected angle related to a standard position of the magnetic ring according to the signals in the form of sine or cosine waves; the operation unit electronically connected to the counter to add the deflected angle and the cyclical number calculated from the counter, and the operation unit calculating the absolute position of the motor according to a process of adding the deflected angle and the cyclical number.

2. The absolute position recording device of the motor of claim 1, wherein each of the plurality of magnets are identical, and magnetic poles of two adjacent magnets are opposite.

3. The absolute position recording device of the motor of claim 1, wherein the magnetic induction unit comprises a first Hall effect element and a second Hall effect element, and a first connecting line between the first Hall effect element and a center of the magnetic ring and a second connecting line between the second Hall effect element and the center of the magnetic ring form an angle.

4. The absolute position recording device of the motor of claim 3, wherein the first Hall effect element and the second Hall effect element output a high level voltage signal (e.g., 1.8V) when a charge is induced by a north magnetic pole of the magnetic ring and output a low level voltage signal (e.g., 0V) when a charge is induced by a south magnetic pole of the magnetic ring.

5. The absolute position recording device of the motor of claim 3, wherein the magnetic ring spins clockwise with the main spindle when a phase of square waves outputted from the first Hall effect element is leading a phase of square waves outputted from the second Hall effect element, and the magnetic ring spins counterclockwise with the main spindle when the phase of the square waves outputted from the second Hall effect element is leading the phase of the square waves outputted from the first Hall effect element.

6. The absolute position recording device of the motor of claim 1, wherein the encoder is an incremental-type encoder.

7. The absolute position recording device of the motor of claim 1, wherein when the magnetic ring spins clockwise with the main spindle, the cyclical number of the magnetic ring calculated by the counter is a positive value, and when the magnetic ring spins counterclockwise with the main spindle, the cyclical number of the magnetic ring calculated by the counter is a negative value.

8. The absolute position recording device of the motor of claim 1, wherein the operation unit is a digital signal processor.

9. The absolute position recording device of the motor of claim 1, further comprising a power-supply unit, and the power-supply unit electronically connected simultaneously to the counter and the operation unit.

10. The absolute position recording device of the motor of claim 9, further comprising a battery unit, and the battery unit electronically connected to the power-supply unit, and the battery unit supplying back-up electrical power when no power is supplied by the power-supply unit.
